(19) United States
(12) Patent Application Publication
(10) Pub. No.: US 2003/0052593 A1
(43) Pub. Date: Mar. 20, 2003

(54) Flat display apparatus and manufacturing method of the same

(76) Inventors: Hiroshi Mori, Kanagawa (JP); Ichiro Utsumi, Tokyo (JP)

Correspondence Address: Ronald P. Kananen, RADER, FISHMAN & GRAUER, PLLC, Suite 501, 1233 20th Street N.W., Washington, DC, 20036, US

(21) Appl. No.: 10/270,185

(22) Filed: Oct. 15, 2002

Related U.S. Application Data
(62) Division of application No. 08/614,881, filed on Mar. 13, 1996, now Pat. No. 5,635,202.

(30) Foreign Application Priority Data
Jul. 15, 1999 (JP) P11-201867

(51) Int. Cl. H01J 1/62; H01J 63/04

(52) U.S. Cl. 313/484

(57) ABSTRACT

In a flat display apparatus, display can be carried out with high definition and high density, and furthermore, driving power, that is, consumed power can be reduced. First and second substrates 1 and 2 are provided opposite to each other, the first substrate 1 is provided with a discharge maintaining electrode group 5 having a plurality of discharge maintaining electrodes 3 and 4 arranged thereon, the second substrate 2 is provided with a plurality of partition walls 9 arranged with a predetermined space held therebetween and an address electrode group 11 having a plurality of address electrodes 10 arranged thereon. The address electrode 10 is formed on at least one side surface except a top face of the partition wall 9 or is formed such that one side edge faces the at least one side surface of the partition wall 9 or is positioned in the vicinity of the side surface, and plasma discharge display is carried out by cathode glow discharge.

### BACKGROUND OF THE INVENTION

1. Field of the Invention

The present invention relates to a flat display apparatus using an AC plasma discharge display and a method of manufacturing the same.

2. Description of the Related Art

For example, Japanese Laid-Open Patent Publication No. 7-220641 has disclosed a flat display apparatus utilizing a plasma discharge.

As an example of a conventional flat display apparatus, for instance, FIG. 12 is a schematic perspective view showing a part cut away, and FIG. 13 is an exploded perspective view showing a flat vessel in which first and second substrates 101 and 102 formed of a glass substrate, for example, are opposed to each other with a predetermined space held therebetween and the surroundings are sealed airtightly.

A discharge maintaining electrode group 105 is provided on the internal surface of the first substrate 101, in which plural pairs of discharge maintaining electrodes 103 and 104 are formed of transparent conductive layers making a pair, for example, and are arranged in parallel.

The discharge maintaining electrodes 103 and 104 formed of the transparent conductive layers have high resistivities and so-called buses 103b and 104b formed of metal layers having resistivities are formed along the side edge opposed to the opposed sides of both electrodes 103 and 104.

Partition walls 106 extended in a direction orthogonal to a direction of extension of the discharge maintaining electrodes 103 and 104 are provided with a predetermined space in parallel and a stripe-shaped address electrode 107 is formed between the partition walls 106 on the internal surface of the second substrate 102. Similarly, phosphors R, G and B having colors for emitting red, green and blue colors, for example, are coated by excitation by vacuum ultraviolet rays generated by plasma discharge between the partition walls 106.

A predetermined discharge starting voltage is applied between a selected address electrode 107 and one of the pair of discharge maintaining electrodes, for example, 103 so that the discharge is started in a portion where they cross. A predetermined alternating voltage is applied between the electrode 103 and the discharge maintaining electrode 104 making a pair therewith so that the discharge in this portion is maintained. By the vacuum ultraviolet rays generated by the discharge, light is emitted from the phosphor positioned in the cross portion and a light emission display to be intended is carried out.

In such a conventional flat display apparatus using a general plasma discharge display, it is presupposed that both the discharge start and the discharge maintenance are carried out through negative glow discharge. For this reason, a space between the address electrode and the discharge maintaining electrode, a space between the pair of discharge maintaining electrodes is set to a space between the electrodes for the generation of the negative glow discharge, that is, 100 μm or more, for example, 130 μm to 200 μm.

### SUMMARY OF THE INVENTION

In the flat display apparatus of this type, recently, there has been a growing demand for restraining an increase in consumed power due to the high density and high definition of pixels and a widening angle of view.

In order to obtain such an increase in the density and definition, it has been required that the space between the electrodes should be reduced.

In the conventional flat display apparatus using the negative glow discharge, however, if the space between the electrodes is reduced to 100 μm or less, the discharge is not fully carried out so that the efficiency of generation of ultraviolet rays is decreased. Consequently, there has been a problem in that the excitation of phosphors becomes insufficient with the result that a lightness is reduced.

The object of the present invention is to enhance the high definition and high density display in a flat display apparatus, and furthermore, to reduce driving power, that is, consumed power.

In the present invention, in the flat display apparatus, both plasma discharge, that is, the discharge (rising) of discharge start and discharge maintenance are mainly carried out by cathode glow discharge, that is, the discharge is almost carried out by the cathode glow discharge, and in other words, even if some negative glow discharge is generated due to an electrode area or the like, the cathode glow discharge is dominantly carried out, substantially by the cathode glow discharge. The cathode glow discharge will be hereinafter referred to as the cathode glow discharge.

The present invention provides a flat display apparatus in which first and second substrates are provided opposite to each other, the first substrate is provided with a discharge maintaining electrode group having a plurality of discharge maintaining electrodes arranged thereon, and the second substrate is provided with a plurality of partition walls arranged with a predetermined space held therebetween and an address electrode group having a plurality of address electrodes arranged thereon.

The address electrode is formed on at least one side surface except a top surface of the partition wall or is formed such that one side edge faces at least the one side surface of the partition wall or is positioned in the vicinity of the side surface, and plasma discharge display is carried out by cathode glow discharge.

Moreover, the present invention provides a method of manufacturing a flat display apparatus comprising the steps of forming, on a first substrate, a discharge maintaining electrode group in which a plurality of discharge maintaining electrodes are arranged in parallel with a main extending direction set to a first direction along the first substrate surface, forming, on the second substrate, a partition wall in which a plurality of partition walls extended in a second direction along the second substrate surface are arranged in parallel, forming an address electrode on at least one side surface except a top face of the partition wall by causing a conductive material to fly downward obliquely to a direction crossing the second direction, forming a phosphor in a groove portion between the adjacent partition walls, and opposing the first and second substrates to seal peripheral portions of the first and second substrates such that the first and second directions cross each other.

Furthermore, the present invention provides a method of manufacturing a flat display apparatus comprising the steps of forming, on a first substrate, a discharge maintaining electrode group in which plural pairs of discharge maintaining electrodes are arranged in parallel with a main extending direction set to a first direction along the first substrate surface, arranging a plurality of stripe-shaped conductive layers extended in a second direction in parallel on the second substrate or an insulating layer formed on the substrate, laminating an insulating layer over the stripe-shaped conductive layers, carrying out grooving to form a partition wall in such a depth as to reach the second substrate or the insulating layer formed on the substrate from the laminated insulating layer, forming a phosphor in a groove portion between the adjacent partition walls, and opposing the first and second substrates to seal peripheral portions of the first and second substrates such that the first and second directions cross each other.

Thus, the partition wall is constituted by the partition wall body and the laminated insulating layer, the address electrode is formed by the conductive layer provided between the partition wall body and the laminated insulating layer, and one side edge of the address electrode formed of the conductive layer is provided to face a side surface of the partition wall or to be positioned in the vicinity of the side surface.

In the flat display apparatus according to the present invention, the discharge display is substantially constituted by the cathode glow discharge. Consequently, driving power can be more reduced as compared with the case of the negative glow discharge, and particularly, power saving effects on large screen display can be enhanced.

Moreover, the space between the discharge maintaining electrodes making a pair for the discharge maintenance can be reduced to 50 μm or less, for example, 20 μm or less, and furthermore, a pixel pitch can be reduced. Thus, high definition and high density display can be obtained.

Referring to a discharge maintaining electrode group 105 having such a structure that the conventional discharge maintenance is carried out by the negative glow discharge, FIG. 14A is a schematic plan view showing a part thereof (illustrating only two pairs of discharge maintaining electrodes 103 and 104) and FIG. 14B is a sectional view taken along the line B-B shown in FIG. 14A, in which the discharge maintaining electrodes 103 and 104 formed of a band-shaped transparent conductive layer are arranged with a space D of 100 μm or more, for example, approximately 130 to 200 μm as described above. A space Dc between an adjacent pair of discharge maintaining electrodes should be minimum. Therefore, even if a width W of each of the discharge maintaining electrodes 103 and 104 is selected to be small, for example, approximately 30 to 40 μm, a pitch P of each set of discharge maintaining electrodes should be set to at least two hundreds and several tens μm, thereby obstructing an increase in the density and definition of displayed pixels.

In the apparatus according to the present invention, moreover, the partition walls are arranged on the second substrate and the address electrode is provided on a side surface or in a position biased toward the side surface. Consequently, electrical isolation between mutual address electrodes is carried out by the partition walls. Accordingly, the discharge portions independent of each other can be formed in the groove portion provided between the side walls. In color display, consequently, the phosphors having respective colors can be sequentially provided in the adjacent groove portions.

In the manufacturing method according to the present invention, in the case in which the address electrode is to be formed on the side surface of the partition wall, the conductive material is formed by flight from an oblique direction to the partition wall. Consequently, the address electrode can be surely formed on the side surface.

In another manufacturing method according to the present invention, moreover, in the case in which the address electrode is to be formed in the partition wall, the partition wall is constituted by a partition wall body and an insulating layer formed thereon and the address electrode is provided therebetween. Consequently, it is possible to surely form the address electrode in a predetermined position.

### BRIEF DESCRIPTION OF THE DRAWINGS

FIG. 1 is a schematic perspective view showing the main part of an example of a flat display apparatus according to the present inventio;

FIG. 2 is a plan view showing the main part of a first substrate 1 of the flat display apparatus in FIG. 1;

FIGS. 3A and 3B are perspective views showing a part of each step of an example of a method of manufacturing the flat display apparatus according to the present invention;

FIGS. 4A and 4B are perspective views showing a part of each step of the example of the method of manufacturing the flat display apparatus according to the present invention;

FIGS. 5A and 5B are perspective views showing a part of each step of the example of the method of manufacturing the flat display apparatus according to the present invention;

FIGS. 6A and 6B are perspective views showing a part of each step of the example of the method of manufacturing the flat display apparatus according to the present invention;

FIG. 7 is a perspective view showing a part of the steps according to the example of the method of manufacturing the flat display apparatus according to the present invention;

FIG. 8 is a schematic perspective view showing the main part of another example of the flat display apparatus according to the present invention;

FIGS. 9A to 9C are sectional views showing a part of each step of the example of the method of manufacturing the flat display apparatus according to the present invention;

FIGS. 10A and 10B are sectional views showing a part of each step of the example of the method of manufacturing the flat display apparatus according to the present invention;

FIG. 11 is a plan view showing an example of a discharge maintaining electrode of the apparatus according to the present invention;

FIG. 12 is a schematic perspective view showing the main part of a conventional device;

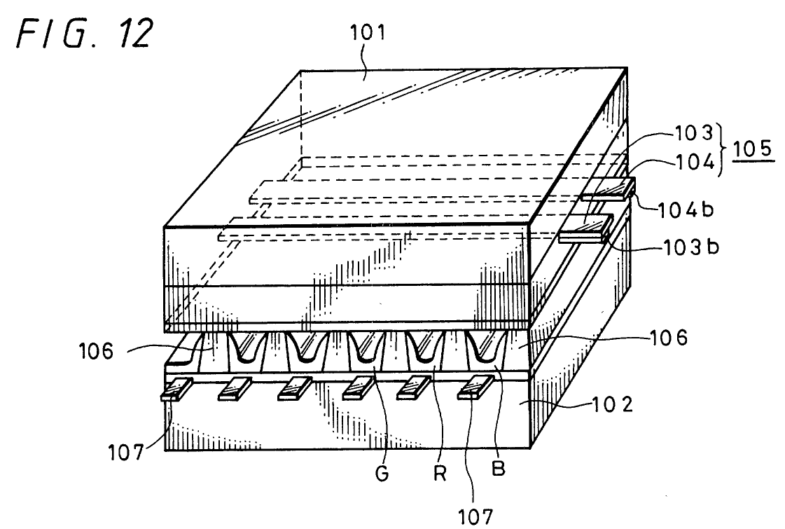

FIG. 13 is an exploded perspective view showing the main part of the conventional device; and

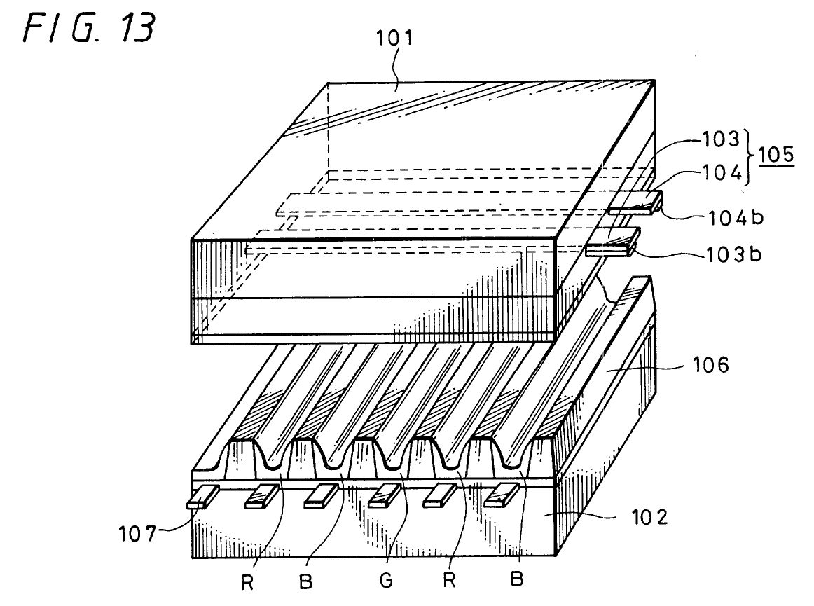

FIGS. 14A and 14B are a plan view showing the arrangement of the discharge maintaining electrode of the conventional apparatus and a sectional view taken along the line B-B.

### DESCRIPTION OF THE PREFERRED EMBODIMENTS

A flat display apparatus according to the present invention is constituted by a flat vessel in which first and second substrates are provided opposite to each other, the surroundings thereof are airtightly sealed with frit seal or the like and a flat space is formed between both substrates.

The first substrate is provided with a discharge maintaining electrode group having a plurality of discharge maintaining electrodes arranged thereon, and the second substrate is provided with a plurality of partition walls arranged in parallel and an address electrode group having a plurality of address electrodes arranged in parallel.

The discharge maintaining electrode group can have such a structure that a plurality of discharge electrodes making pairs for discharge maintenance are arranged in parallel maintaining a required space to each other by using a main extending direction thereof set to one direction (hereinafter referred to as an X direction) along the substrate surface of the first substrate.

The partition walls are extended along the substrate surface of the second substrate in a direction crossing, for example, orthogonal to, the X direction (hereinafter referred to as a Y direction) and formed by being arranged in parallel maintaining a required space to each other, and the address electrode is formed on at least one side surface of each partition wall, for example.

The address electrode can also be formed across the bottom face of a groove portion between mutually opposed surfaces of the adjacent partition walls.

As described above, the address electrode can also be formed on the side surface of the partition wall, and can be formed of a conductive layer extended in the extending direction of the partition wall in each partition wall such that one side edge is positioned facing one of the side surface of the partition wall or in the vicinity of the side surface and is provided in a position biased toward the side surface.

In the case in which the address electrode is thus formed of the conductive layer, each partition wall can have such a structure that the partition wall is formed by a partition wall body and a laminated insulating layer formed on a top surface thereof, for example and the above-mentioned conductive layer, that is, the address electrode is provided between the partition wall body and the laminated insulating layer.

The address electrode can be provided on both side surfaces of each partition wall respectively, for example. In this case, the address electrodes for both side surfaces of the partition wall are electrically isolated from each other. In this case, the mutual address electrodes for the mutually opposed surfaces of the adjacent partition walls are electrically coupled to each other at ends thereof. Alternatively, the address electrode is extended over the bottom part of the groove portion between the partition walls across the address electrodes on the opposed surfaces so that the address electrodes are electrically coupled mutually as described above.

It is possible to employ such a structure that a common terminal can be led from the address electrode mutually coupled to each other.

The inside of the groove portion between the mutual opposed surfaces of the adjacent partition walls is coated with a phosphor for emitting light by excitation by vacuum ultraviolet rays generated by plasma discharge which will be described below.

In the display apparatus for carrying out color display, for example, phosphors R, G and B for light emission with red, green and blue colors are formed with such an arrangement that the inside of every third groove portion is sequentially coated with each of the phosphors.

A space between the address electrode for starting, that is, initiating a discharge and a discharge maintaining electrode to be a discharge electrode opposite thereto is selected to be 50 μm or less, preferably 20 μm or less, for example, 10 μm.

Moreover, a space between the discharge maintaining electrodes making a pair for the discharge maintenance of the discharge maintaining electrode group is also selected to be 50 μm or less, preferably, 20 μm or less, for example, 10 μm.

Furthermore, a grid-shaped projection is formed on the first substrate.

The grid-shaped projection is constituted by a projection portion extended in a Y direction opposed to each partition wall, for example, of the second substrate and a crossing projection portion crossing the projection portion and extended in an X direction in sets of counter electrodes in which the discharge maintenance of the discharge maintaining electrodes is carried out.

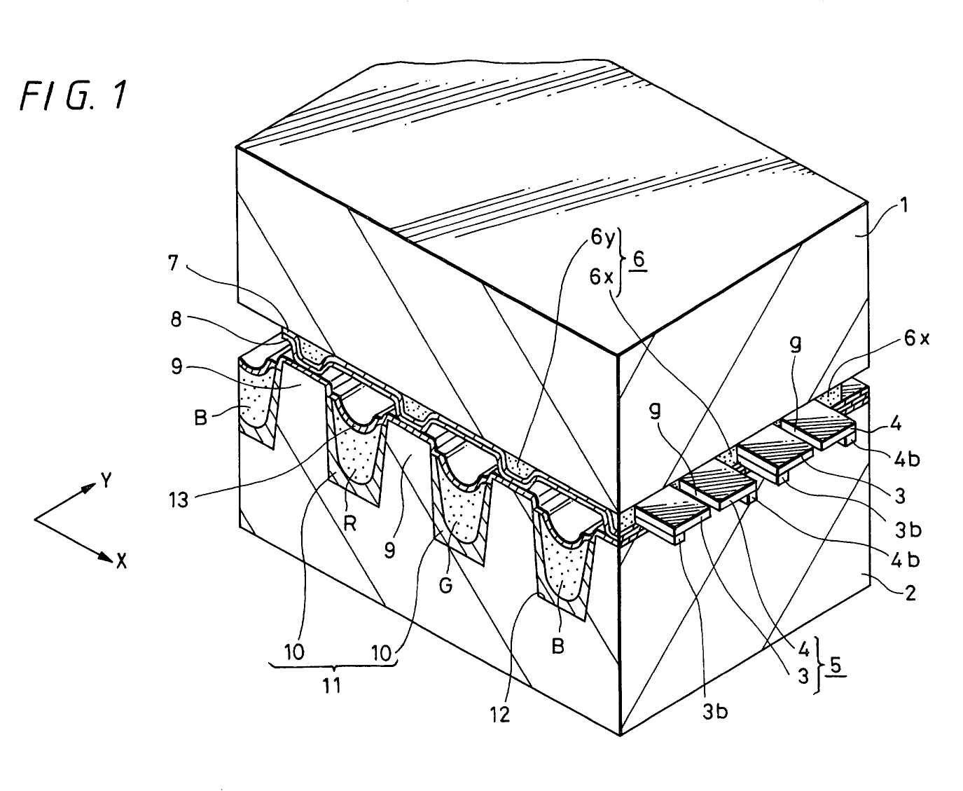

Next, an example of an embodiment of the flat display apparatus according to the present invention will be described with reference to FIG. 1 which is a schematic sectional perspective view showing a part thereof and the apparatus according to the present invention is not restricted to this example.

In the apparatus according to the present invention, for example, the first and second substrates 1 and 2 formed of a glass substrate, are opposed to each other and the surroundings of both substrates 1 and 2 are airtightly sealed with frit seal or the like, which is not shown.

In this example, the first substrate 1 is a front face side substrate and a light emission display is observed on the first substrate 1 side. In this case, at least the first substrate 1 is formed by a transparent glass substrate through which display light is transmitted.

The internal surface of the first substrate 1 is provided with the discharge maintaining electrode group 5 in which plural sets of discharge maintaining electrodes 3 and 4 making pairs at a time of discharge maintenance by a transparent conductive layer, for example, ITO (indium tin oxide) are arranged in parallel with each other like a stripe, for example, with a main extending direction thereof extended in an X direction along the plate surface of the substrate 1.

The space between both electrodes 3 and 4 opposed to each other is selected to be small such that a cathode glow discharge is substantially generated, that is, 50 μm or less, preferably 20 μm or less, for example, 10 μm.

In the case in which the discharge maintaining electrodes 3 and 4 are to be formed of a transparent conductive layer, since its conductive property is comparatively poor, so-called bus electrodes 3b and 4b having small widths which are made of a material having an excellent conductive property for compensating for the conductive properties of the discharge maintaining electrodes 3 and 4, for example, Al are formed in the main extending direction of the discharge maintaining electrode.

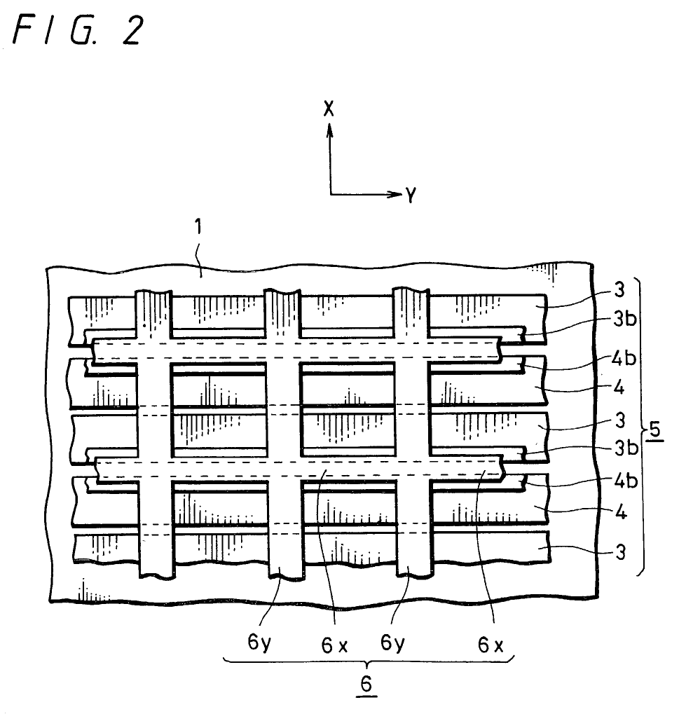

In the first substrate 1, as shown in the schematic plan view of FIG. 2 showing a main part thereof, a grid-shaped projection 6 is formed in which a projection portion 6y extended in a direction crossing the X direction, for example, an orthogonal Y direction across the discharge maintaining electrodes 3 and 4 are arranged in parallel at a predetermined space corresponding to the arrangement space of the partition walls 9 formed on the second substrate 2 side which will be described below and a crossing projection portion 6x crossing the projection portion 6y and extended in the X direction is formed.

The crossing projection portion 6x is formed partially straddling or without straddling the discharge maintaining electrodes 3 and 4 between the set of discharge maintaining electrodes making a pair.

A dielectric layer 7 made of SiO₂, for example, is wholly provided on the internal surface of the first substrate 1 in a thickness which is equal to or less than half of a space d between the discharge maintenance electrodes 3 and 4, for example, and furthermore, a surface layer 8 made of MgO, for example, which has a small work function and serves to protect the electrodes is formed.

As shown in FIG. 1, a plurality of stripe-shaped partition walls 9 extended in the Y direction are arranged in parallel on the internal surface of the second substrate 2. The partition walls 9 are selected to have a space corresponding to the projection portion 6y of the projection 6 of the first substrate 1 as described above.

An address electrode 10 is formed on the side surface in the Y direction except the tops of the partition walls 9 so that the address electrode group 11 is formed.

In the example shown in FIG. 1, each address electrode 10 is formed over both side surfaces and a bottom face, that is, like a sectional U-shape in the groove portion 12 provided between the adjacent partition walls 9.

The inside of the groove portion 12 is coated with the phosphors R, G and B for emitting light having red, green and blue colors by the excitation by the vacuum ultraviolet rays generated by plasma discharge which will be described below alternately, that is, every third groove portion 12.

Moreover, the surface layer 13 made of MgO described above is formed covering, for example, the electrode 10 and the phosphors covered.

With such a structure, the partition wall 9 and the projection portion 6y of the grid-shaped projection 6 are caused to face each other through the dielectric layer 7 and the surface layers 8 and 13 in the shown example, and the space between the first and second substrates 1 and 2 is selected depending on heights and thicknesses thereof, and simultaneously selected to be a predetermined space between the address electrode 10 and the discharge maintaining electrode 3 or 4 in which the discharge start is carried out together with the address electrode 10, in particular, a space in which the cathode glow discharge is carried out, that is, 50 μm or less, preferably 20 μm or less, for example, 10 μm.

Thus, discharge regions isolated from others by confinement of discharge through cooperation of the projection portion 6y and the partition wall 9 of the first and second substrates 1 and 2 are formed, in which pixel areas for emitting light having various colors are formed.

An airtight space formed by the first and second substrates 1 and 2 is exhausted and is filled with a predetermined gas, for example, one or more of He, Ne, Ar, Xe, Kr gases, for example, a mixed gas of Ne and Xe, that is, a so-called Penning gas at such a pressure as to stably maintain a discharge having a high luminance and a high efficiency, for example, 0.05 to 5.0 atm.

Also in the apparatus according to the present invention, a required discharge starting voltage is applied between the selected address electrode 10 and one of the pair of the discharge maintaining electrodes, for example, the discharge maintaining electrode 3, thereby causing the discharge to start in a portion where they cross, and a predetermined alternating voltage is applied between the electrode 3 and the discharge maintaining electrode 4 making the pair therewith, thereby maintaining discharge in this portion and causing the phosphor positioned in the crossing portion to emit light by the vacuum ultraviolet rays generated by the discharge. Thus, the light emission display to be intended is carried out.

At this time, in the apparatus according to the present invention, the starting of the discharge, that is, the discharge start is carried out by the cathode glow discharge because the space between the address electrode 10 and the discharge maintaining electrode 3 is 50 μm or less, for example, 10 μm, and furthermore, by the cathode glow discharge because the space with the discharge maintaining electrode for performing the discharge maintenance is also selected to be 50 μm or less, for example, 10 μm.

Thus, the flat display apparatus according to the present invention has such a structure that both the discharge and the discharge maintenance at the time of the discharge start are carried out by the cathode glow discharge. Therefore, driving power can be more reduced as compared with the case of negative glow discharge. In particular, it is possible to reduce consumed power which is a problem in a large screen display.

Moreover, the space between the discharge maintaining electrodes can be made smaller. Therefore, a pixel pitch can be reduced so that a display with high definition and high density can be carried out.

Next, a description will be given to an example of an embodiment of a method of manufacturing the flat display apparatus according to the present invention. While the flat display apparatus having the structure shown in FIG. 1 is obtained in this example, the manufacturing method according to the present invention is not restricted to this example.

First of all, an example of the manufacturing method on the first substrate 1 side will be described.

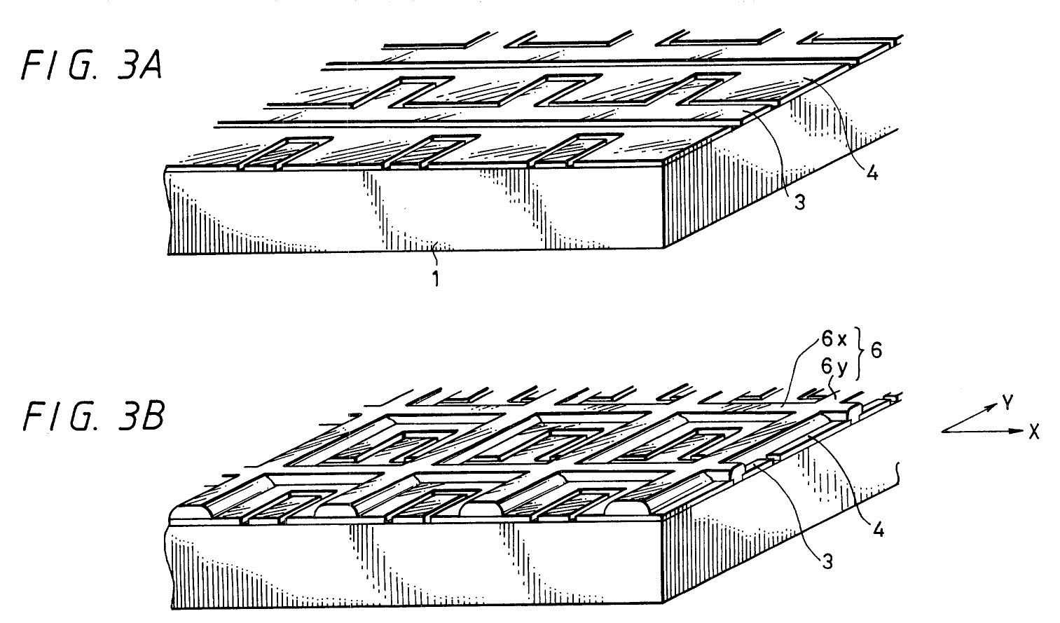

In this case, a first substrate 1 formed of a transparent glass substrate, for example, is prepared as shown in the schematic perspective view of FIG. 3A showing a part thereof, and the discharge maintaining electrodes 3 and 4 are formed on the internal surface of the substrate 1.

The discharge maintaining electrodes 3 and 4 are formed by wholly forming a transparent conductive layer such as ITO in a thickness of approximately 300 nm, for example, on the internal surface of the substrate 1 and carrying out pattern etching through photolithography to have a required pattern, in the shown example, a zigzag pattern in which side edges opposed to each other hold a predetermined space. More specifically, a photoresist layer is coated and baked on the ITO wholly formed, for example, and the predetermined pattern is exposed and developed to form an etching mask having a pattern corresponding to the patterns of the discharge maintaining electrodes 3 and 4 to be intended. Then, the transparent conductive layer is subjected to etching using an etchant to be a mixed solution of hydrochloric acid and iron (III) chloride, for example, by means of the etching mask, thereby forming the discharge maintaining electrodes 3 and 4.

Next, bus electrodes 3b and 4b shown in FIGS. 1 and 2 are formed if necessary, which are not shown in FIG. 3. The bus electrodes 3b and 4b are formed by, first of all, wholly depositing Al having a high conductive property, for example, in a thickness of approximately 1 μm over the discharge maintaining electrode groups 3 and 4 on the internal surface of the first substrate 1 and performing the pattern etching through the photolithography in the same manner as described above using phosphoric acid as an etchant, for example. Thus, the bus electrodes 3b and 4b are formed to have partial widths of the electrodes 3 and 4 along the side edges on the sides opposite to the opposed sides over the discharge maintaining electrodes 3 and 4.

As shown in FIG. 3B, then, the grid-shaped projection 6 having the projection portion 6y and the crossing projection portion 6x described above is formed in a height of 20 μm and a width of 30 μm to 40 μm, for example, by a printing method, for example.

Thereafter, the dielectric layer 7 made of SiO₂, for example, illustrated in FIG. 1 is wholly formed by a CVD (Chemical Vapor Deposition) method or the like, which is not shown, and MgO is deposited thereon in a thickness of approximately 0.5 μm to 1.0 μm, for example, and the surface layer 8 is thus formed.

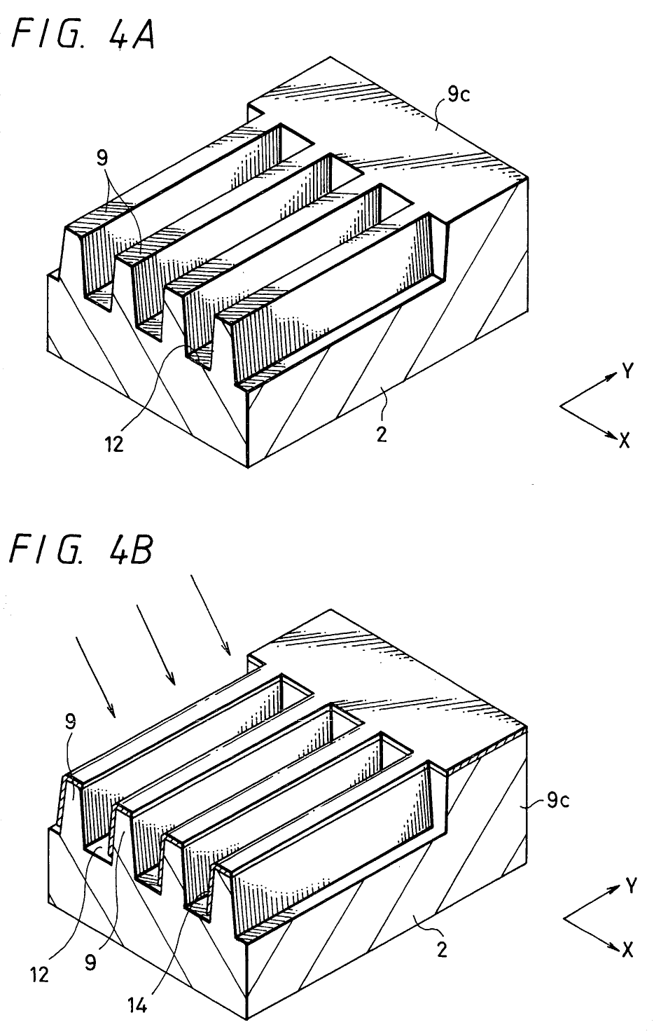

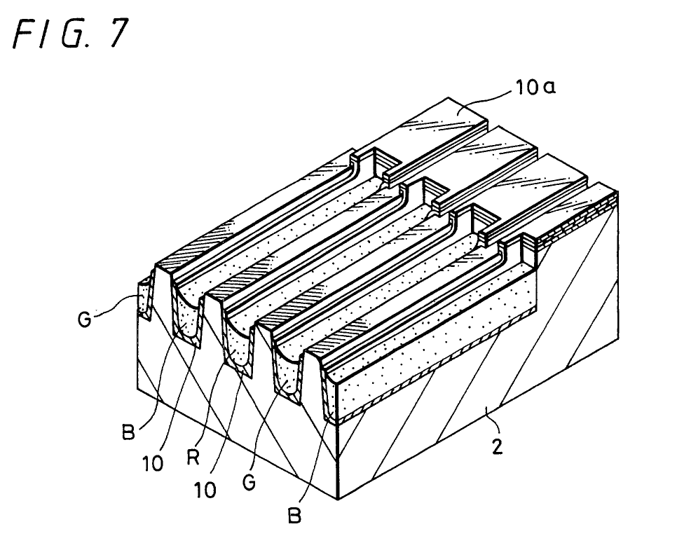

Next, an example of the manufacturing method related to the second substrate will be described with reference to A and B of FIGS. 4 to 6 which are perspective views showing a part of each step and FIG. 7.

In this case, as shown in FIG. 4A, the second substrate formed of a glass substrate, for example, is prepared and the partition walls 9 are extended in a Y direction on a main surface thereof and are arranged in parallel at a predetermined space in an X direction. A coupling portion 9c for mutually coupling both ends of the partition walls 9 is formed (only one of the ends is shown in FIG. 4).

The partition walls 9 and the coupling portion 9c can be formed by the printing method. For example, a glass paste is overprinted plural times. In this case, a thickness for onetime printing is approximately 10 μm. By repeating the printing, stripe-printing is carried out at a height (thickness) of 50 μm to 80 μm. Then, baking is carried out at a temperature of 500° C. to 600° C., for example. Thus, the partition wall 9 having a height of 30 μm to 60 μm can be formed.

Thereafter, a conductive layer is formed on at least one side surface of the partition wall 9 except the top of the partition wall 9. Thus, the address electrode is formed. In this example, the address electrode is formed across both side surfaces of the partition wall 9 and the bottom face of the groove portion 12 formed between the partition walls 9.

In this case, first of all, a conductive material 14 is mainly attached to one of the side surfaces of the partition wall 9 formed in the Y direction as shown in FIG. 4B from an obliquely upward direction of one corresponding side surface side of the partition wall 9 as diagrammatically shown by an arrow.

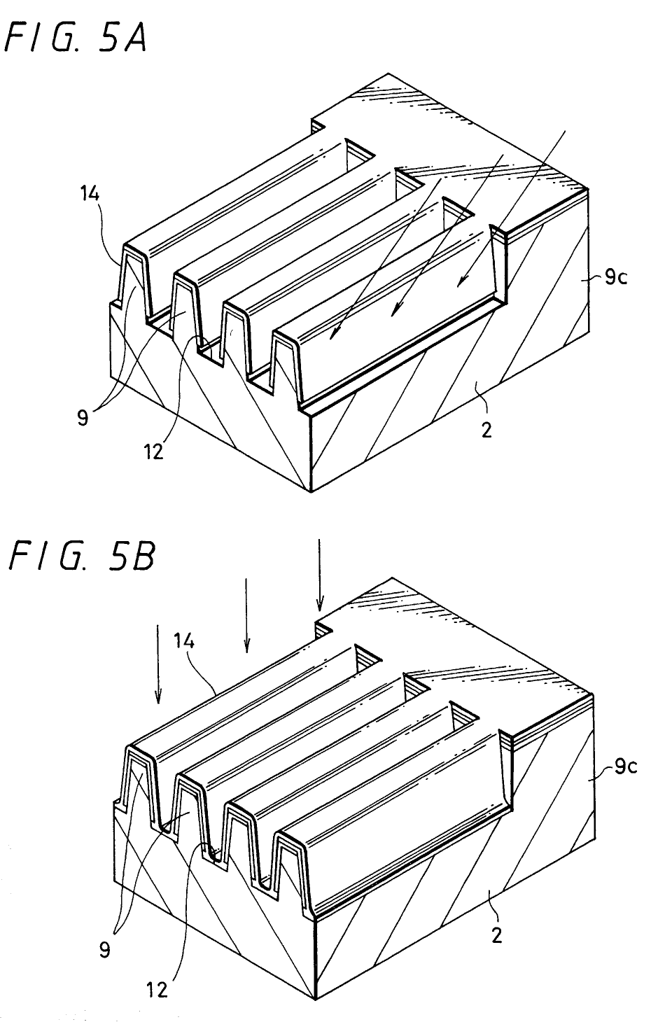

Nextly, as diagrammatically shown by an arrow of FIG. 5A, the same conductive material 14 such as Al is caused to fly by a deposition method having a directionality in the flight direction from an obliquely upward direction of the other side surface side of the partition wall 9, that is, the obliquely upward direction of the side opposite to the obliquely upward direction described in FIG. 4B and is mainly attached to the other side surface of the partition wall 9.

As diagrammatically shown by an arrow of FIG. 5B, furthermore, the same conductive material such as Al is caused to fly along an almost vertical direction of a substrate surface from above the substrate 1 so that the conductive material 14 is attached to the bottom part in the groove portion 12.

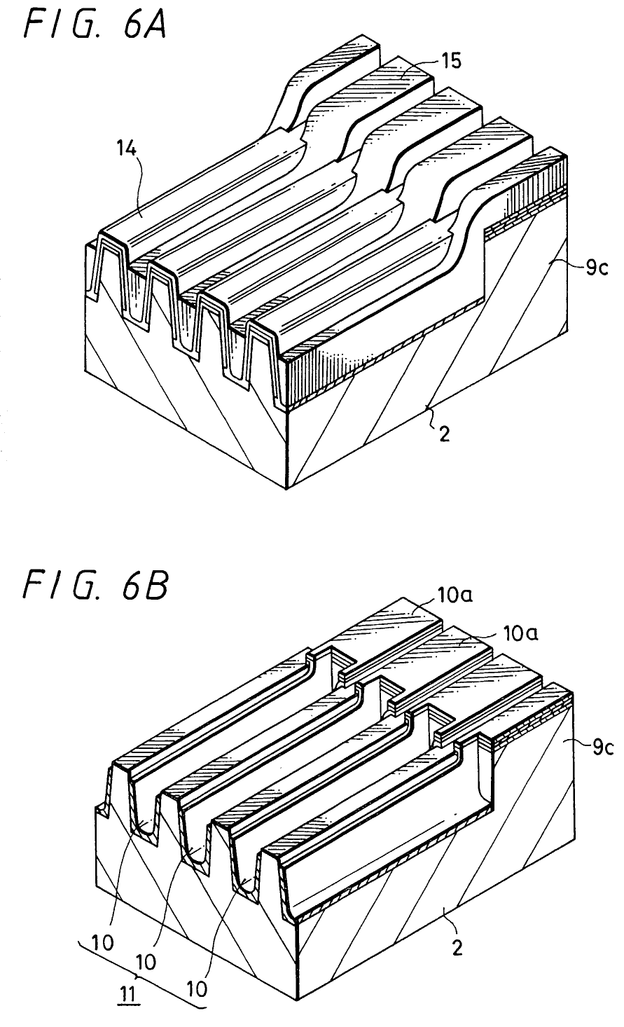

As shown in FIG. 6A, then, a stripe-shaped etching resist 15 using a photoresist, for example, is formed by photolithography extending from each groove portion 12 to the upper portion of the coupling portion 9c.

In this case, the thickness of the etching resist 15 in the groove portion 12 is selected such that the conductive material 14 formed on the top of the partition wall 9 can be exposed to the outside.

Nextly, the conductive material 14 is etched by using the etching resist 15 as a mask, thereby removing the conductive material 14 provided on the top of the partition wall 9 across the coupling portion 9c. Thus, the conductive material 14 formed on both side surfaces of the partition wall 9 is electrically isolated.

As shown in FIG. 6B, then, the etching resist 15 is removed.

Thus, an address electrode group 11 where an address 10 is formed by the conductive material 14 provided on the bottom surface of the groove portion 12 and each of the side surfaces of the partition wall 9 opposed to each other with the bottom surface interposed therebetween is formed.

In this case, a terminal portion 10a extended to the upper portion of the coupling portion 9c of the partition wall 9 can be formed on the end of each address electrode 10.

While all the terminal portions 10a of the address electrode 10 are formed on the same end portion in the example of FIG. 6B, they can also be led from both ends of the groove portion 12 of every other adjacent address electrode 10, for example.

As shown in FIG. 7, then, phosphors R, G and B having red, green and blue colors are formed by work of repeating the coating and baking a photosensitive phosphor slurry, for example, having the phosphors R, G and B sequentially having each of the colors in the groove portion 12 between the partition walls 9.

As shown in FIG. 1, furthermore, the surface layer 13 made of MgO or the like is wholly formed.

Thus, the second substrate 2 is manufactured.

Thereafter, the first and second substrates 1 and 2 are mde to oppose each other in the above-mentioned positional relationship and are exhausted and filled with the predetermined gas after having the surroundings subjected to frit seal as described above. Consequently, an intended flat display apparatus is obtained.

In this case, the terminal portions of the electrodes 3 and 4 and the terminal portion 10a of the address electrode 10 are led to the outside portion, extended outside an airtight space, of the substrates 1 and 2 and can be power supply terminals, respectively.

In the above-mentioned example, each address electrode 10 is formed across the inner side surface and bottom surface of the groove portion 12. When the address electrode 10 is thus formed on the bottom surface of the groove portion 12, the electrode 10 functions as a so-called light reflecting surface and can reflect rearward light emission from the phosphors R, G and B and can efficiently lead the light emission toward the front panel side, that is, forward from the first substrate 1. Thus, the effect of bright display can be obtained. However, the electrode 10 can also be formed on only one side surface of the groove portion 12, for example. In this case, the steps of FIGS. 5A and 5B can be omitted.

Moreover, in the case in which the address electrode 10 is to be formed on only both side surfaces except the bottom surface of the groove portion 12, the step of FIG. 5B can be omitted.

In the above-mentioned method, the partition wall 9 is formed by overprinting of the repetitive pattern with a glass paste. For example, the partition wall 9 can also be formed by wholly performing printing in a thickness of 50 μm to 80 μm, for example, drying and patterning through sand blast. In this case, a mask for the sand blast is formed. The mask is formed by wholly laminating a photosensitive film and exposing, printing out and developing the photosensitive film like a parallel stripe. Thus, a mask having a required pattern is formed. Then, a glass layer in an unnecessary portion is removed by sand blasting through the opening of the mask. Therefore, the photosensitive film is removed and baking is carried out at 500° C. to 600° C. Consequently, the partition wall 9 having a required height can be formed.

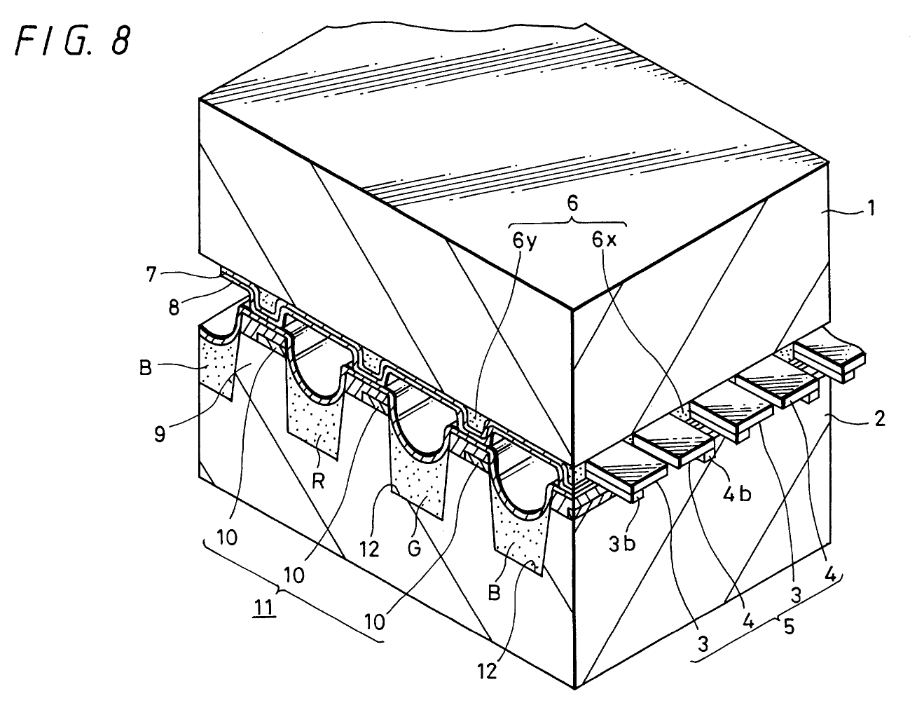

In the above-mentioned example, the address electrode 10 is formed in the groove portion 12. As shown in the sectional perspective view of FIG. 8 showing a part, a stripe-shaped conductive layer forming the address electrode 10 in the partition wall 9 can be formed by being buried in order to extend in the extending direction (Y direction) of the partition wall 9.

In this example, the address electrode 10 is biased toward one corresponding side surface of the partition wall 9, and one side edge of the address electrode 10 is formed to face one corresponding side surface of the partition wall 9.

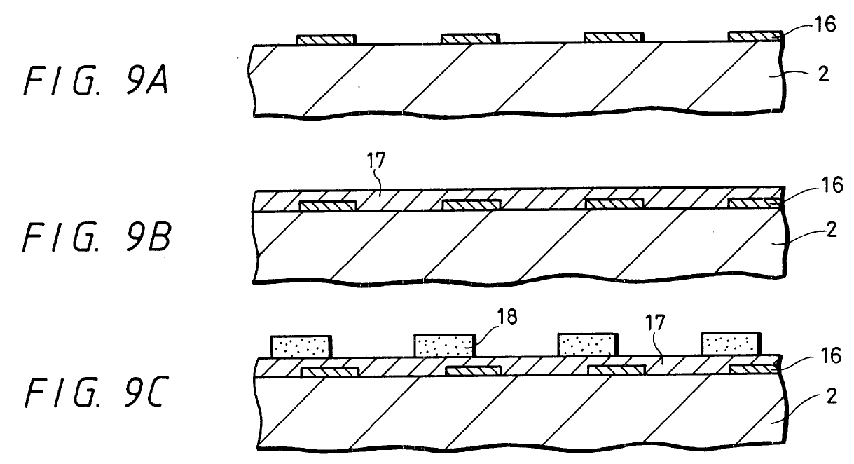

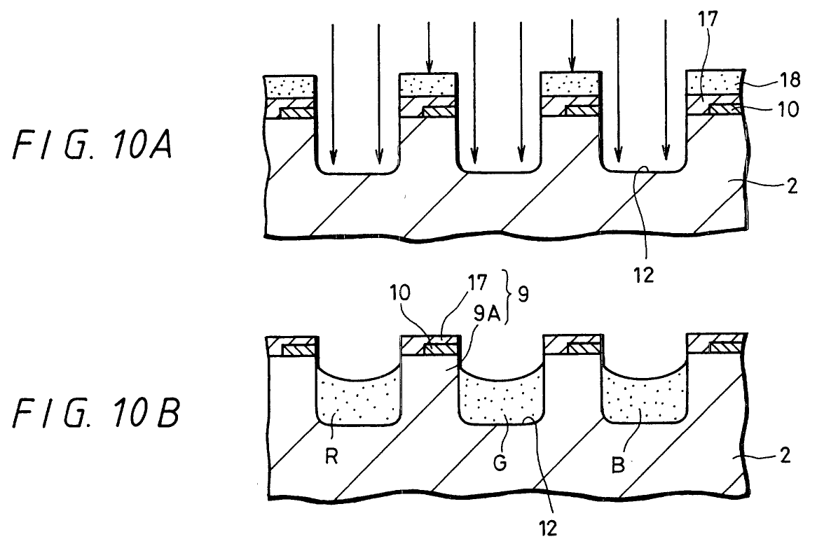

An example of a method of forming the address electrode 10 and the partition wall 9 will be described below with reference to the schematic sectional views of FIGS. 9 and 10 showing a part of each step.

In this case, as shown in FIG. 9A, a conductive layer 16 finally forming an address electrode is extended in the Y direction orthogonal to the paper of the drawing and is provided in a stripe-shape on the second substrate 2 or an insulating layer formed on the second substrate 2. The formation of the stripe-shaped conductive layer 16 is carried out by wholly forming a conductive material such as Al by deposition, for example, and then setting a predetermined width and space through pattern etching by photolithography.

Alternatively, the conductive layer 16 having the above-mentioned pattern is formed by printing a conductive paste such as a silver paste.

As shown in FIG. 9B, then, an insulating layer 17 is wholly formed by wholly printing and drying an insulating paste such as a lead glass paste, for example.

Nextly as shown in FIG. 9C, a stripe-shaped sand blast mask 18 extended in the extending direction of the conductive layer 16, that is, the Y direction is formed over one side edge of the stripe-shaped conductive layer 16, for example. The mask 18 is formed by providing a dry film resist on the insulating layer 17, for example, and then exposing, developing and removing the portion, where the groove portion 12 is formed.

As diagrammatically shown in an arrow of FIG. 10A, thereafter, the sand blast is carried out from above the substrate 2 and a portion which is not covered with the mask 18 is engraved. Consequently, the groove portion 12 is formed, that is, the partition wall 9 is formed between the groove portions 12.

As shown in FIG. 10B, subsequently, the mask 18 is removed.

Thus, the partition wall 9 having the insulating layer 17 provided on a so-called partition wall body 9A is formed. Then, the address electrode 10 having an edge facing one side surface of the partition wall 9 is formed.

Thereafter, the phosphors R, G and B having respective colors are formed in predetermined array order in the groove portion 12, for example, by screen printing or the like.

Subsequently, the flat display apparatus according to the present invention shown in FIG. 8 which is intended is obtained through the same steps as those described above.

According to the manufacturing method of the present invention, it is possible to obtain the flat display apparatus of the present invention in which a space between the address electrode and the discharge maintaining electrode and a space between the discharge maintaining electrodes 3 and 4 are so reduced as to carry out the above-mentioned cathode glow discharge.

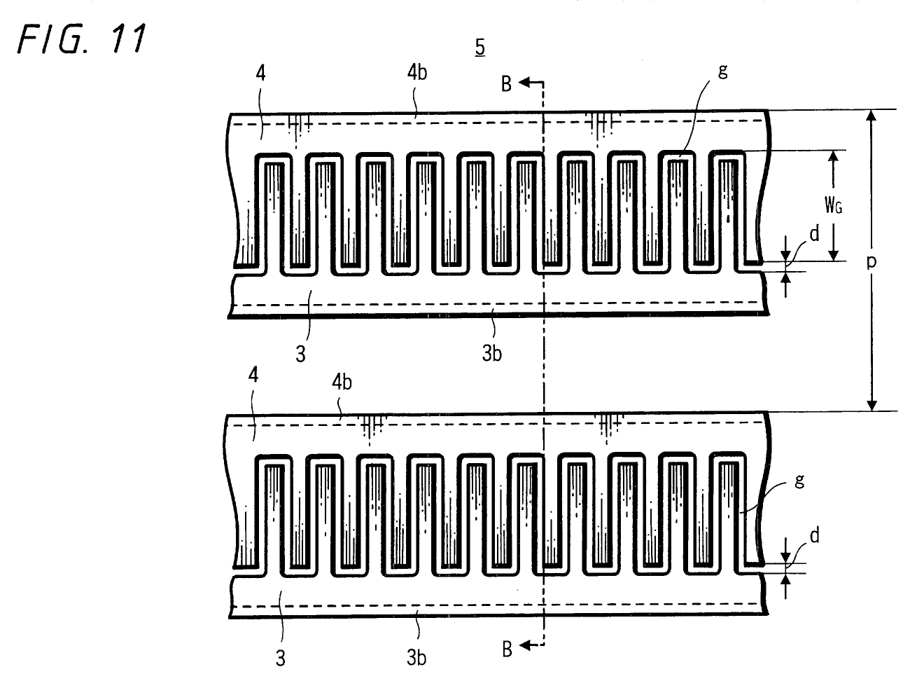

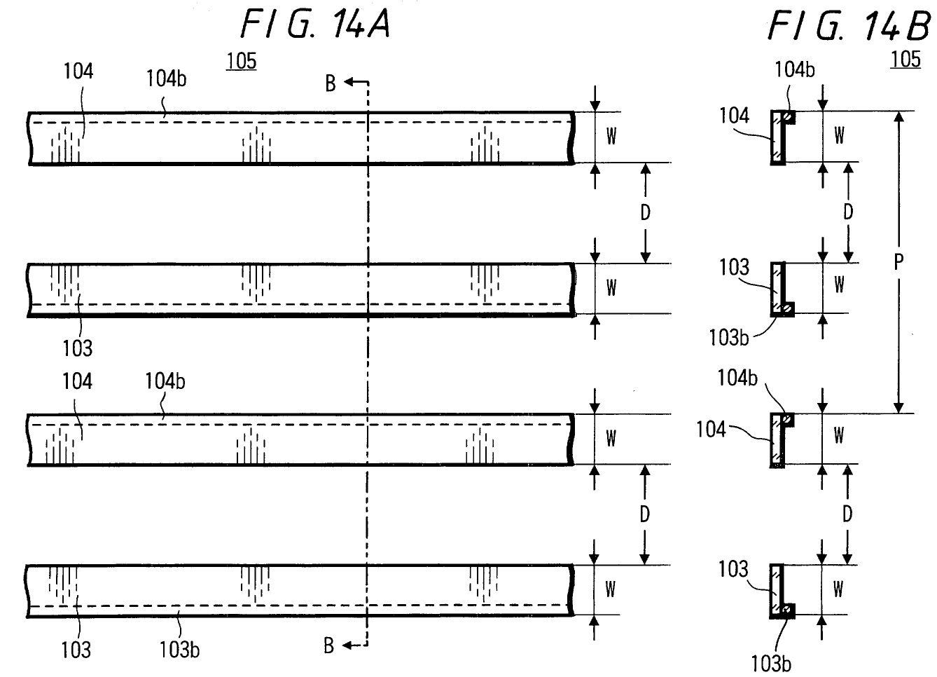

In FIG. 11 typically showing the arrangement of two pairs of discharge maintaining electrodes 3 and 4, for example, a space of the structure according to the present invention, that is, a space d of a gap g is set to d<<D as compared with a space D between the discharge maintaining electrodes 103 and 104 in the conventional example shown in FIG. 14, for example. Therefore, when a pitch p is selected to be almost equal to a conventional pitch P, a width ω of the electrodes 3 and 4 can be set to be ω≦≦W as compared with a conventional width W.

Consequently, the conductive properties of the electrodes 3 and 4 in the longitudinal direction can be enhanced. At this time, the width occupied by the electrodes 3 and 4 can be increased. Therefore, the gap g between both discharge maintaining electrodes 3 and 4 can be curved or bent as shown in FIG. 11 and an amplitude W_{G} can be fully increased so that the opposed length of the gap can be increased, the efficiency of the discharge can be enhanced, the generation of vacuum ultraviolet rays can be increased and luminance can be more enhanced.

The flat display apparatus and the manufacturing method according to the present invention are not restricted to the above-mentioned example, and they can be variously modified and changed.

For example, the first and second substrates 1 and 2 can be constituted by front and rear panels themselves forming an airtight flat vessel constituting the flat display apparatus, or can be constituted by substrates opposed to each other which are provided in the airtight flat vessel as described above. Thus, various modifications and changes can be carried out.

While the light emission display is observed on the first substrate 1 side in the above-mentioned example, it may be observed on the second substrate 2 side. In this case, the address electrode 8 is constituted by a transparent conductive layer.

As described above, in the present device, the cathode glow discharge is mainly carried out. Consequently, the driving power can be more reduced than the case of the negative glow discharge. Alternatively, when the driving power is to be set equal to or almost equal to that in the conventional example, it is possible to enhance the efficiency of light emission and a light emitting luminance. For example, when the driving power is to be equal to that in the conventional example, a brightness can be increased by 40% or more.

Moreover, the address electrode 10 is formed on the side surface of the partition wall 9. Therefore, the space between the address electrode 10 and the discharge maintaining electrode can be selected to be fully small, for example, 50 μm or less, and furthermore, 20 μm or less at which the cathode glow discharge can be generated as described above.

The discharge space can be maintained to be great in the groove portion 12 set by the partition wall 9. Moreover, the phosphors R, G and B are formed between the partition walls 9. Therefore, the coating area of the phosphors can be kept large so that bright display can be carried out.

Moreover, the phosphors R, G and B are coated on the adjacent groove portions 12. Consequently, a pixel pitch can be fully reduced.

Furthermore, the space between the discharge maintaining electrodes 3 and 4 is much smaller than that in the conventional example. For example, the space can be reduced to 1/10 or less. Therefore, an arrangement pitch p of each pair of discharge maintaining electrodes can be more reduced than a conventional pitch P. Consequently, the density and definition of the pixel can be enhanced.

Then, a reduction in the driving power causes heat generation to be decreased. Therefore, it is possible to avoid the use of a heat radiating fan or to reduce the number of the heat radiating fans or power or to reduce the number of the heat radiating fans, the area or the like. Consequently, it is possible to reduce the size and weight of the whole apparatus and the like in large area display.

Furthermore, since the shape of the gap g between the set of discharge maintaining electrodes is set to have a curved or bent pattern, the length thereof can be increased. Consequently, it is possible to carry out discharge having a higher efficiency, that is, to increase the amount of generated vacuum violet rays. Thus, the luminance can be more enhanced.

In the actual manufacture, moreover, in the case in which the first and second substrates 1 and 2 are formed of a glass substrate, in particular, an inexpensive lead glass or the like, great shrinkage is caused by heat treatment in the manufacturing process. The shrinkage, for example 10 cm, spreads over 20 μm to 30 μm by heat treatment at several hundreds ° C., and furthermore, a variation for each product is great. Moreover, the shrinkage is varied in the central and peripheral parts of a screen. Therefore, in the case in which the step of forming electrodes having a plurality of patterns are to be carried out on the same substrate, an error is made in each portion for the alignment of an exposure mask or the like in the pattern etching, for example, or a variation is caused for each product. For this reason, particularly when the distance between the discharge electrodes is to be set to be less than 50 μm, preferably, 20 μm or less as in the cathode glow discharge, high dimensional precision should be particularly required. Therefore, yield and reliability have problems.

However, in the case in which the discharge maintaining electrodes making a pair are formed on the first substrate 1 and the address electrode is formed on the second substrate 2 as described above, the discharge maintaining electrodes making a pair are formed at the same steps. Moreover, the address electrode is formed on the second substrate 2 separately from the discharge maintaining electrode. Consequently, it is possible to mutually prevent the influence of a positional shift from being caused by the influence of heat. Therefore, also in the case in which the cathode glow discharge is carried out for both the discharge of the discharge start and that of the discharge maintenance, manufacture can be carried out to obtain, with high precision, the space between the address electrode and the discharge maintaining electrode and the space between the discharge maintaining electrodes which are intended.

As described above, moreover, when the projection 6 is to be grid-shaped, the space between the substrates 1 and 2, that is, the space between the address electrode and the discharge maintaining electrode can be held to be a predetermined space even if a shift is caused between both substrates 1 and 2.

According to the manufacturing method of the present invention, moreover, although the address electrode of the flat display apparatus according to the present invention which is intended is formed on the side surface of the partition wall, it can be formed easily and surely by the flight of a conductive material in an oblique direction or the formation of a conductive layer in the partition wall. Thus, it is possible to obtain a flat display apparatus which can have high reliability and uniform characteristics.

Having described preferred embodiments of the present invention with reference to the accompanying drawings, it is to be understood that the present invention is not limited to the above-mentioned embodiments and that various changes and modifications can be effected therein by one skilled in the art without departing from the spirit or scope of the present invention as defined in the appended claims.

What is claimed is:

1. A flat display apparatus in which first and second substrates are provided opposite to each other,
the first substrate is provided with a discharge maintaining electrode group having a plurality of discharge maintaining electrodes arranged thereon,
the second substrate is provided with a plurality of partition walls arranged with a predetermined space held therebetween and an address electrode group having a plurality of address electrodes arranged thereon,
the address electrode is formed on at least one side surface except a top face of the partition wall or is formed such that one side edge faces the at least one side surface of the partition wall or is positioned in the vicinity of the side surface, and
plasma discharge display is mainly carried out by cathode glow discharge.

2. The-flat display apparatus according to claim 1, characterized in that the discharge maintaining electrode is arranged such that a main extending direction thereof is set to a first direction along a substrate surface of the first substrate, and
the partition wall is extended along the substrate surface in a second direction crossing the first direction and is arranged in parallel on the second substrate.

3. The flat display apparatus according to claim 1, wherein the address electrode is formed across a bottom face of a groove between adjacent partition walls.

4. The flat display apparatus according to claim 1, wherein the address electrodes are mutually isolated electrically from each other with respect to both side surfaces of the partition wall, and
the address electrodes for opposed side surfaces of the adjacent partition walls are electrically coupled to each other on an end.

5. The flat display apparatus according to claim 1, wherein the partition wall is formed by a partition wall body and a laminated insulating layer provided on the partition wall body, and
the address electrode is formed by a conductive layer provided between the partition wall body and the laminated insulating layer and one side edge of the dielectric layer is arranged to face the side surface of the partition wall or to be positioned in the vicinity of the side surface.

6. The flat display apparatus according to claim 1, wherein a phosphor is coated in a groove portion between mutual opposed surfaces of the adjacent partition walls.

7. The flat display apparatus according to claim 1, wherein phosphors emitting light having red, green and blue colors are sequentially coated in every third groove portion between the mutual opposed surfaces of the adjacent partition walls.

8. The flat display apparatus according to claim 1, wherein a space between the address electrode and the discharge maintaining electrode opposed to the address electrode is selected to be 50 μm or less and discharge start is mainly carried out by cathode glow discharge.

9. The flat display apparatus according to claim 1, wherein a space between the address electrode and the discharge maintaining electrode opposed to the address electrode is selected to be 20 μm or less and discharge start is mainly carried out by cathode glow discharge.

10. The flat display apparatus according to claim 2, further comprising a grid-shaped projection having a projection portion extended in the second direction and a crossing projection portion extended in a direction crossing the partition wall is formed on the first substrate.

11. A method of manufacturing a flat display apparatus comprising the steps of:
forming, on a first substrate, a discharge maintaining electrode group in which a plurality of discharge maintaining electrodes are arranged in parallel with a main extending direction set to a first direction along the first substrate surface;
forming, on the second substrate, a partition wall in which a plurality of partition walls extended in a second direction along the second substrate surface are arranged in parallel;
forming an address electrode on at least one side surface except a top face of the partition wall by causing a conductive material to fly downward obliquely to a direction crossing the second direction;
forming a phosphor in a groove portion between the adjacent partition walls; and
opposing the first and second substrates to seal peripheral portions of the first and second substrates such that the first and second directions cross each other.

12. A method of manufacturing a flat display apparatus comprising the steps of;
forming, on a first substrate, a discharge maintaining electrode group in which plural pairs of discharge maintaining electrodes are arranged in parallel with a main extending direction set to a first direction along the first substrate surface,
arranging a plurality of stripe-shaped conductive layers extended in a second direction in parallel on the second substrate or an insulating layer formed on the substrate;
laminating an insulating layer over the stripe-shaped conductive layers;
carrying out grooving to form a partition wall in such a depth as to reach the second substrate or the insulating layer formed on the substrate from the laminated insulating layer;
forming a phosphor in a groove portion between the adjacent partition walls; and
opposing the first and second substrates to seal peripheral portions of the first and second substrates such that the first and second directions cross each other;
wherein the partition wall is constituted by the partition wall body and the laminated insulating layer; and
the address electrode is formed by the conductive layer provided between the partition wall body and the laminated insulating layer and one side edge of the address electrode formed of the conductive layer is provided to face a side surface of the partition wall or to be positioned in the vicinity of the side surface.
